(19) United States
(12) Patent Application Publication
(10) Pub. No.: US 2020/0374268 A1
(43) Pub. Date: Nov. 26, 2020

(54) Cloud-Native Firewall

(71) Applicant: AT&T Intellectual Property I, L.P., Atlanta, GA (US)

(72) Inventors: Robert Marcus Wyatt, Grand Prairie, TX (US); James Fox, Dallas, TX (US); Rene Glover, Forney, TX (US); Venkatesham Nalla, Robbinsville, NJ (US)

(73) Assignee: AT&T Intellectual Property I, L.P., Atlanta, GA (US)

(21) Appl. No.: 16/419,415

(22) Filed: May 22, 2019

(51) Int. Cl. H04L 29/06

(52) U.S. Cl. CPC H04L 63/0236; H04L 63/0876; H04L 63/102; H04L 63/20

(57) ABSTRACT

According to one aspect disclosed herein, a cloud-native firewall system can receive, from a client operating in a first network, a request for access to a service operating in a second network. In response, the cloud-native firewall system can retrieve, from a service registry, metadata associated with the service. The cloud-native firewall system can execute, based at least in part upon the metadata, a policy rule to determine whether to allow/deny the client access to the service. The metadata can include a dynamic IP address and a port number associated with a system that provides, at least in part, the service. The metadata can further include an authentication type and an authentication provider. If the cloud-native firewall system determines to allow access to the service, the cloud-native firewall can forward the request to the service for processing. Otherwise, the cloud-native firewall system can block access to the service.

### BACKGROUND

Cloud computing allows dynamically scalable, often virtualized resources to be provided as a service. Cloud computing can assure an appropriate level of resources are available to power software applications (i.e., cloud-native applications) when and where the resources are needed in response to demand. As a result, cloud computing allows entities to respond quickly, efficiently, and in an automated fashion to the rapidly changing business environment.

The rise of cloud-native applications requires changes in security techniques. Traditional network firewalls are manually configured to allow or deny access to users and/or systems based on fixed identity (e.g., static IP address). Cloud-native applications are designed to be automatically managed by an orchestration system across a cluster of hardware hosts. As a cloud orchestration system launches new instances or moves existing instances, network interfaces get assigned and unassigned dynamically resulting in frequent identity changes. Due to this dynamic, ephemeral, and autonomous behavior, traditional firewalls will not scale in the cloud-native world.

### SUMMARY

Concepts and technologies disclosed herein are directed to a cloud-native firewall. According to one aspect of the concepts and technologies disclosed herein, a cloud-native firewall system can receive, from a client operating in a first network, a request for access to a service operating in a second network. In response to the request, the cloud-native firewall system can retrieve, from a service registry, metadata associated with the service. The cloud-native firewall system can execute, based at least in part upon the metadata, a policy rule to determine whether to allow or deny the client access to the service. In response to determining to allow the client access to the service, the cloud-native firewall system can forward the request to the service for processing. In response to determining to deny the client access to the service, the cloud-native firewall system can deny the client access to the service.

The metadata can include a dynamic IP address associated with a system that provides, at least in part, the service. The metadata can further include a port number associated with the system that provides, at least in part, the service. The metadata can further include an authentication type and authentication provider.

The service registry can be a first service registry instance operating in the first network. In these embodiments, the metadata associated with the service can be obtained by the first service registry instance via synchronization with a second service registry instance operating in the second network. The service can provide the metadata to the second service registry instance during a registration process.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating aspects of an operating environment in which a traditional firewall can be implemented.

FIG. 2 is a flow diagram illustrating aspects of a method for implementing a traditional firewall.

FIG. 3 is a block diagram illustrating aspects of an operating environment in which aspects of the concepts and technologies disclosed herein for a cloud-native firewall system can be implemented.

FIG. 4 is a flow diagram illustrating aspects of a method for implementing a cloud-native firewall system, according to an illustrative embodiment of the concepts and technologies disclosed herein.

FIG. 5 is a block diagram illustrating aspects of an illustrative cloud computing platform capable of implementing aspects of embodiments of the concepts and technologies disclosed herein can be implemented.

FIG. 6 is a block diagram illustrating an example mobile device and component thereof capable of implementing aspects of the embodiments presented herein.

FIG. 7 is a block diagram illustrating an example computer system capable of implementing aspects of the embodiments presented herein.

FIG. 8 is a diagram illustrating a network, according to an illustrative embodiment.

### DETAILED DESCRIPTION

The concepts and technologies disclosed herein are directed to a cloud-native firewall that can allow or deny access to services based upon policy rules driven by metadata associated with the services. This enables an automated ability of cloud computing to securely control cross-network traffic to cloud-native services without the need to manually modify traditional firewall rules. As services are started, the services can be registered dynamically in a service registry. The concepts and technologies disclosed herein provide redundant cross-network service registry instances with synchronized data and network topology awareness. This allows the service registry instances to provide known cloud-native firewall instance information to clients when making a cross-network request. The concepts and technologies disclosed herein also can provide additional metadata during a service registration process. This additional metadata can include specific details regarding the policies implemented by the service.

Dynamically allowing or denying connectivity to services across networks, based on metadata-driven policies, is beneficial for driving scale and speed for cloud-native architectures. The ability for services to leverage metadata describing specific implementation details and for a policy enforcement point to discover and apply rules is an innovative and new concept. This will save significant time and effort in the deployment and management of services, which reduces costs and increases reliability. Current solutions require manual configuration for each new service. Manual processes will not scale in the highly dynamic and ever-changing cloud-native world.

While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer systems, including hand-held devices, mobile devices, wireless devices, multiprocessor systems, distributed computing systems, microprocessor-based or programmable consumer electronics, minicomputers, mainframe computers, routers, switches, other computing devices described herein, and the like.

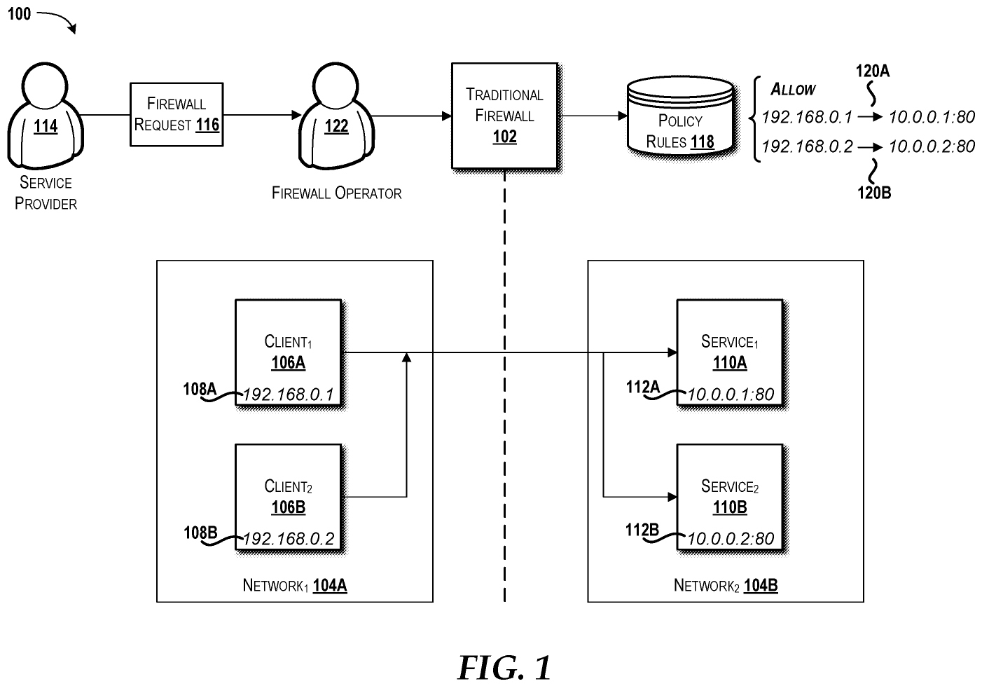

Turning now to FIG. 1, a block diagram illustrating aspects of an operating environment 100 in which a traditional firewall 102 can be implemented will be described. The traditional firewall 102 can be implemented as a hardware firewall or a software firewall. The illustrated operating environment 100 includes a first network (“network₁”) 104A and a second network (“network₂”) 104B. A first client (“client₁”) 106A and a second client (“client₂”) 106B are illustrated as operating in communication with the network₁ 104A via static client IP addresses 108A, 108B, respectively. A first service (“service₁”) 110A and a second service (“service₂”) 110B are illustrated having static service IP addresses/ports 112A, 112B, respectively, and as operating in the network₂ 104B. Traditionally, to enable connectivity across networks, such as between the network₁ 104A and the network₂ 104B, a service provider (e.g., a human representative thereof) 114 performs a manual process to create a firewall request 116 to enable the one or more policy rules 118 for a given service, such as the service₁ 110A or the service₂ 110B. In the illustrated example, the policy rules 118 include the source IP addresses, such as the static client 108A, 108B (associated with the clients 106A, 106B), mapped to destination IP addresses/port numbers, such as the static service IP addresses/ports 112A, 112B (associated with the services 110A, 110B). For example, the firewall request 116 can include a firewall rule 120A that can be defined to allow the client₁ 106A associated with the static client IP address 108A (192.168.0.1) to access the service₁ 110A associated with the static service IP address/port 112A (10.0.0.1:80); and another firewall rule 120B can be defined to allow the client₂ 106B associated with the static client IP address 108B (192.168.0.2) to access the service₂ 110A associated with the static service IP address/port 112B (10.0.0.2:80). A firewall operator 122 (also human) typically receives the firewall request 116 via e-mail, although other messaging applications or custom applications by which requests can be queued and manually addressed have been used as those skilled in the art will understand. The firewall operator 122 manually configures the traditional firewall 102 for the firewall rules 120A, 120B defined in the firewall request 116. When the clients 106A, 106B request access to the services 110A, 110B, the traditional firewall 102 references the policy rules 118 and the firewall rules 120A, 120B to determine whether to allow access. Other clients (not shown) for which the firewall rules 120A, 120B have not been established need to be manually created via the process described above for each new client that has a static IP address.

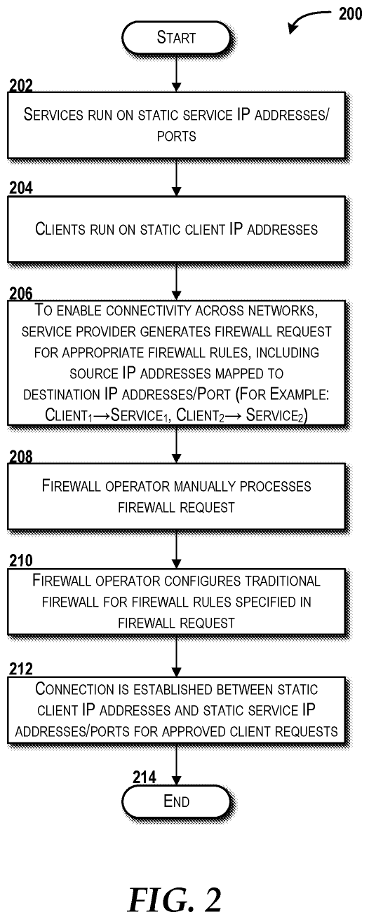

Turning now to FIG. 2, aspects of a method 200 for implementing the traditional firewall 102 will be described. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, servers, routers, switches, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor or other processing component(s) disclosed herein to perform operations. It should be understood that the performance of one or more operations may include operations executed by one or more virtual processors at the instructions of one or more of the aforementioned hardware processors.

The method 200 will be described with reference to FIG. 2 and additional reference to FIG. 1. The method 200 begins and proceeds to operation 202, where the services 110A, 110B run on static IP address/ports 112A, 112B. From operation 202, the method 200 proceeds to operation 204, where the clients 106A, 106B run on the static client IP addresses 108A, 108B. From operation 204, the method 200 proceeds to operation 206, where, to enable connectivity across the networks 104A, 104B, the service provider 114 generates the firewall request 116 for the appropriate firewall rules 120A, 120A, including the source IP addresses mapped to the destination IP addresses/ports (e.g., client₁->service₁, client₂->service₂).

From operation 206, the method 200 proceeds to operation 208, where the firewall operator 122 manually processes the firewall request 116. For example, the firewall operator 122 can retrieve the firewall request 116 from his/her e-mail inbox, review the firewall request, and define the firewall rules 120A, 120B to accommodate the firewall request 116. From operation 208, the method 200 proceeds to operation 210, where the firewall operator 122 configures the traditional firewall 102 for the firewall rules 120A, 120B specified in the firewall request 116. From operation 210, the method 200 proceeds to operation 212, where a connection is established between the static client IP addresses 108A, 108B and the static service IP addresses/ports 112A, 112B for client requests approved in accordance with the firewall rules 120A, 120B. From operation 212, the method 200 proceeds to operation 214, where the method 200 ends.

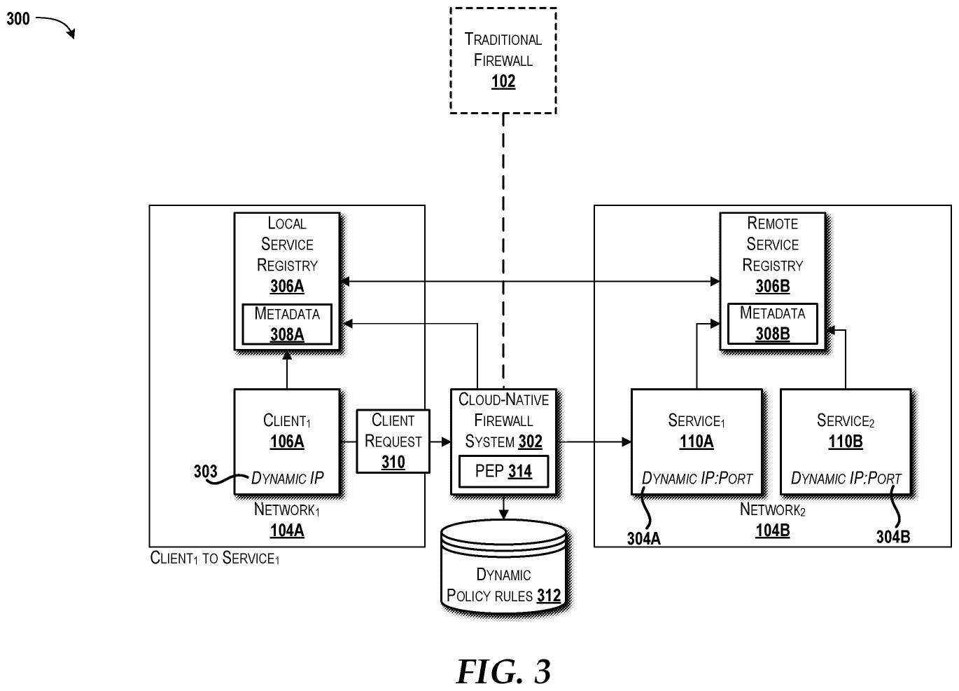

Turning now to FIG. 3, a block diagram illustrating aspects of a new operating environment 300 in which aspects of the concepts and technologies disclosed herein for a cloud-native firewall system 302 can be implemented will be described. The new operating environment 300 includes the network₁ 104A and the network₂ 104B introduced in FIG. 1. The client₁ 106A is again shown operating in the network₁ 104A, and both the services 110A, 110B are again shown operating in the network₂ 104B; however, in the new operating environment 300, the client₁ 106A is associated with a dynamic client IP address 303, and each of the services 110A, 110B is associated with a dynamic service IP address/port 304A, 304B, respectively. The network₁ 104A also includes a first service registry instance 306A (also referred to herein and illustrated as “local service registry 306A”; local with respect to the client₁ 106A). The network₂ 104B likewise includes a second service registry instance 306B (also referred to herein and illustrated as “remote service registry 306B”; remote with respect to the client₁ 106A). When the services 110A, 110B start-up during a registration process, metadata 308 (shown as metadata 308B) associated with the services 110A, 110B is published to the remote service registry 306B. The metadata 308 can include the host IP addresses and ports upon which one or more systems associated with the services 110A, 110B are running and any policy metadata. The policy metadata can specify, for example, any authentication credentials required by the client 106A to access the services 110A, 110B, the authentication types, and the authentication provider. The metadata 308 can additionally or alternatively include a service name, a service version, a service description, geo-coordinates, or any combinations thereof. The remote service registry 306B can synchronize the metadata 308 across one or more other registry instances, including the local service registry 306A in the illustrated example (shown as metadata 308A).

The client₁ 106A can perform a look-up operation via the local service registry 306A to receive instructions regarding how to connect to the services 110. The local service registry 306A is network topology aware and can instruct the client₁ 106A regarding how to route one or more client requests 310 through the cloud-native firewall 302 to call or otherwise interact with the services 110A, 110B. The cloud-native firewall 302, in response, can execute any dynamic firewall policy rules 312 associated with one or more dynamic firewall policies and can automatically determine whether to allow or deny the client request 310 via a policy enforcement point (“PEP”) 314. When allowed, the cloud-native firewall system 302 forwards the client request 310 to the requested service (service₁ 110A or service₂ 110B) for processing.

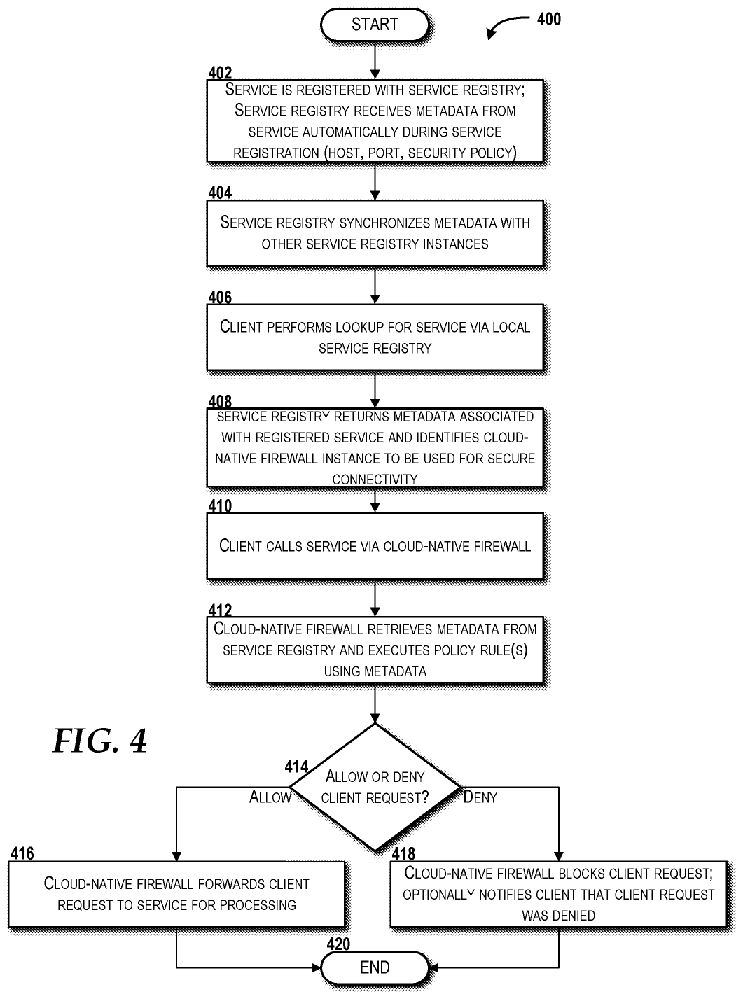

Turning now to FIG. 4, a method 400 for implementing the cloud-native firewall system 302 will be described, according to an illustrative embodiment. The method 400 will be described in context of the service₁ 110A operating in the network₂ 104B, registering with the remote service registry 306B, and providing the metadata 308B, including the dynamic service IP address/port 304A and policy metadata, to the remote service registry 306B, which then populates one or more peer registry instances, including the local service registry 306A from which the client₁ 106A can perform service lookup and discovery to locate the service₁ 110A in the network₂ 104B as described in the operations below. Although the method 400 is described in this context, those skilled in the art will appreciate that the concepts represented in the method 400 can be expanded to any number of services 110 operating in any number of networks 104 having any number of service registries 306 that can be used by any number of clients 106 to perform service lookup and discovery to locate any number of services 110 via any number of cloud-native firewall system 302 instances. As such, the illustrated embodiment should not be construed as limiting to the specific configuration described and illustrated with reference to FIG. 3.

The method 400 begins and proceeds to operation 402, where the service₁ 110A is registered with the remote service registry 306B. During the registration process, the remote service registry 306B receives the metadata 308B from the service₁ 110A. The metadata 308B can include the host IP address, the port number, and policy metadata for the system(s) that host the service₁ 110A. From operation 402, the method 400 proceeds to operation 404, where the remote service registry 306B synchronizes the metadata 308B with one or more other service registry instances such as the local service registry 306A (shown as the metadata 308A in FIG. 3).

From operation 404, the method 400 proceeds to operation 406, where the client₁ 106A performs lookup for the service₁ 110A via the local service registry 306A. The local service registry 306A is network topology-aware and knows the metadata 308A that was synchronized with the remote service registry 306B with which the service₁ 110A registered. From operation 406, the method 400 proceeds to operation 408, where the local service registry 306A returns the metadata 308A associated with the service₁ 110A that registered with the remote service registry 306B at operation 402. Also, at operation 408, the local service registry 306A can identify the specific cloud-native firewall system 302 instance if multiple cloud-native firewall instances are implemented.

From operation 408, the method 400 proceeds to operation 410, where the client₁ 106A calls the service₁ 110A via the cloud-native firewall system 302. In particular, the client₁ 106A can generate the client request 310 directed to the service₁ 110A and can send the client request 310 to the service₁ 110A via the cloud-native firewall system 302. In this manner, the client₁ 106A uses the cloud-native firewall system 302 in a forward proxy configuration.

From operation 410, the method 400 proceeds to operation 412, where the cloud-native firewall system 302 retrieves the metadata 308A from the local service registry 306A and executes any of the dynamic firewall policy rules 312 using the metadata 308A associated with the service₁ 110A. From operation 412, the method 400 proceeds to operation 414, where the cloud-native firewall system 302 automatically determines, based upon execution of the dynamic firewall policy rule(s) 312 whether to allow or deny the client request 310. If the cloud-native firewall system 302 determines, based upon the dynamic firewall policy rule(s) 312, to allow the client request 310, the method 400 proceeds to operation 416, where the cloud-native firewall system 302 forwards the client request 310 to the service₁ 110A for processing. If, however, the cloud native firewall 302 determines, based upon the dynamic firewall policy rule(s) 312 to deny the client request 310, the method 400 proceeds to operation 418, where the cloud-native firewall system 302 blocks the client request 310. Optionally, the cloud native firewall 302 can notify the client₁ 106A that the client request 310 was denied. A reason for why the client request 310 was denied also can be provided. From either operation 416 or operation 418, the method 400 proceeds to operation 420, where the method 400 ends.

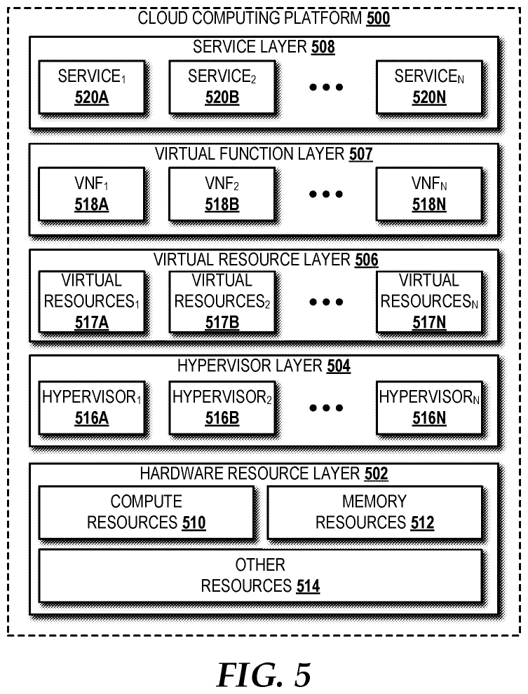

Turning now to FIG. 5, an illustrative cloud computing platform 500 will be described, according to an illustrative embodiment. The cloud computing platform 500 includes a hardware resource layer 502, a hypervisor layer 504, a virtual resource layer 506, a virtual function layer 507, and a service layer 508. While no connections are shown between the layers illustrated in FIG. 5, it should be understood that some, none, or all of the components illustrated in FIG. 5 can be configured to interact with one other to carry out various functions described herein. In some embodiments, the components are arranged so as to communicate via one or more networks. Thus, it should be understood that FIG. 5 and the remaining description are intended to provide a general understanding of a suitable environment in which various aspects of the embodiments described herein can be implemented and should not be construed as being limiting in any way.

The hardware resource layer 502 provides hardware resources. In the illustrated embodiment, the hardware resource layer 502 includes one or more compute resources 510, one or more memory resources 512, and one or more other resources 514. The compute resource(s) 510 can include one or more hardware components that perform computations to process data and/or to execute computer-executable instructions of one or more application programs, one or more operating systems, and/or other software. In particular, the compute resources 510 can include one or more central processing units (“CPUs”) configured with one or more processing cores. The compute resources 510 can include one or more graphics processing unit (“GPU”) configured to accelerate operations performed by one or more CPUs, and/or to perform computations to process data, and/or to execute computer-executable instructions of one or more application programs, one or more operating systems, and/or other software that may or may not include instructions particular to graphics computations. In some embodiments, the compute resources 510 can include one or more discrete GPUs. In some other embodiments, the compute resources 510 can include CPU and GPU components that are configured in accordance with a co-processing CPU/GPU computing model, wherein the sequential part of an application executes on the CPU and the computationally-intensive part is accelerated by the GPU processing capabilities. The compute resources 510 can include one or more system-on-chip (“SoC”) components along with one or more other components, including, for example, one or more of the memory resources 512, and/or one or more of the other resources 514. In some embodiments, the compute resources 510 can be or can include one or more SNAPDRAGON SoCs, available from QUALCOMM of San Diego, Calif.; one or more TEGRA SoCs, available from NVIDIA of Santa Clara, Calif.; one or more HUMMINGBIRD SoCs, available from SAMSUNG of Seoul, South Korea; one or more Open Multimedia Application Platform (“OMAP”) SoCs, available from TEXAS INSTRUMENTS of Dallas, Tex.; one or more customized versions of any of the above SoCs; and/or one or more proprietary SoCs. The compute resources 510 can be or can include one or more hardware components architected in accordance with an ARM architecture, available for license from ARM HOLDINGS of Cambridge, United Kingdom. Alternatively, the compute resources 510 can be or can include one or more hardware components architected in accordance with an x86 architecture, such an architecture available from INTEL CORPORATION of Mountain View, Calif., and others. Those skilled in the art will appreciate the implementation of the compute resources 510 can utilize various computation architectures, and as such, the compute resources 510 should not be construed as being limited to any particular computation architecture or combination of computation architectures, including those explicitly disclosed herein.

The memory resource(s) 512 can include one or more hardware components that perform storage/memory operations, including temporary or permanent storage operations. In some embodiments, the memory resource(s) 512 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 510.

The other resource(s) 514 can include any other hardware resources that can be utilized by the compute resources(s) 510 and/or the memory resource(s) 512 to perform operations described herein. The other resource(s) 514 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 502 can be virtualized by one or more hypervisors 516A-516N (also known as “virtual machine monitors”) operating within the hypervisor layer 504 to create virtual resources that reside in the virtual resource layer 506. The hypervisors 516A-516N can be or can include software, firmware, and/or hardware that alone or in combination with other software, firmware, and/or hardware, creates and manages virtual resources 517A-517N operating within the virtual resource layer 506.

The virtual resources 517A-517N operating within the virtual resource layer 506 can include abstractions of at least a portion of the compute resources 510, the memory resources 512, and/or the other resources 514, or any combination thereof. In some embodiments, the abstractions can include one or more virtual machines, virtual volumes, virtual networks, and/or other virtualizes resources upon which one or more VNFs 518A-518N can be executed. The VNFs 518A-518N in the virtual function layer 507 are constructed out of the virtual resources 517A-517N in the virtual resources layer 506. In the illustrated example, the VNFs 518A-518N can provide, at least in part, one or more services 520A-520N in the service layer 508. The services 520A, 520N, in some embodiments, can include the services 110A, 110B illustrated and described above with reference to FIGS. 1 and 3.

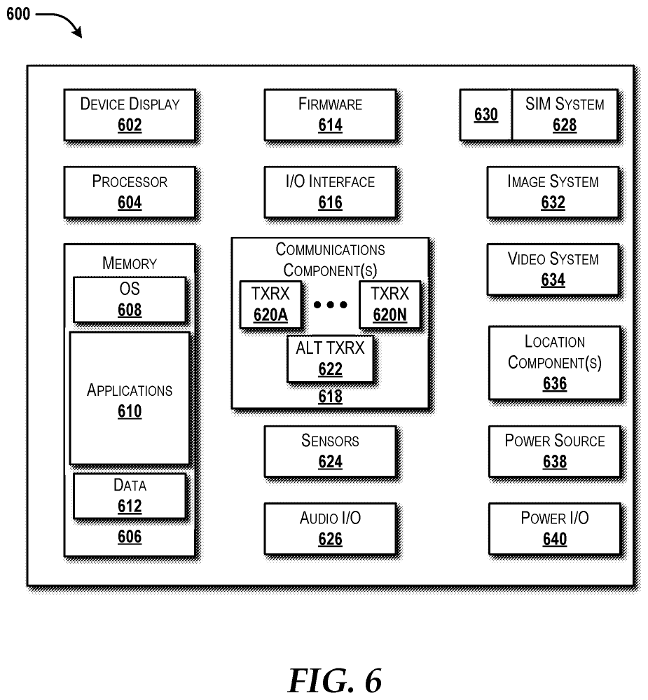

Turning now to FIG. 6, an illustrative mobile device 600 and components thereof will be described. In some embodiments, the clients 106 described above with reference to FIGS. 1 and 3 can be configured as and/or can have an architecture similar or identical to the mobile device 600 described herein with respect to FIG. 6. It should be understood, however, that the clients 106 may or may not include the functionality described herein with reference to FIG. 6. While connections are not shown between the various components illustrated in FIG. 6, it should be understood that some, none, or all of the components illustrated in FIG. 6 can be configured to interact with one other to carry out various device functions. In some embodiments, the components are arranged so as to communicate via one or more busses (not shown). Thus, it should be understood that FIG. 6 and the following description are intended to provide a general understanding of a suitable environment in which various aspects of embodiments can be implemented, and should not be construed as being limiting in any way.

As illustrated in FIG. 6, the mobile device 600 can include a device display 602 for displaying data. According to various embodiments, the device display 602 can be configured to display any information. The mobile device 600 also can include a processor 604 and a memory or other data storage device (“memory”) 606. The processor 604 can be configured to process data and/or can execute computer-executable instructions stored in the memory 606. The computer-executable instructions executed by the processor 604 can include, for example, an operating system 608, one or more applications 610, other computer-executable instructions stored in the memory 606, or the like. In some embodiments, the applications 610 also can include a UI application (not illustrated in FIG. 6).

The UI application can interface with the operating system 608 to facilitate user interaction with functionality and/or data stored at the mobile device 600 and/or stored elsewhere. In some embodiments, the operating system 608 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 604 to aid a user in interacting with data. The UI application can be executed by the processor 604 to aid a user in answering/initiating calls, entering/deleting other data, entering and setting user IDs and passwords for device access, configuring settings, manipulating address book content and/or settings, multimode interaction, interacting with other applications 610, and otherwise facilitating user interaction with the operating system 608, the applications 610, and/or other types or instances of data 612 that can be stored at the mobile device 600.

According to various embodiments, the applications 610 can include, for example, a web browser application, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 610, the data 612, and/or portions thereof can be stored in the memory 606 and/or in a firmware 614, and can be executed by the processor 604. The firmware 614 also can store code for execution during device power up and power down operations. It should be appreciated that the firmware 614 can be stored in a volatile or non-volatile data storage device including, but not limited to, the memory 606 and/or a portion thereof.

The mobile device 600 also can include an input/output (“I/O”) interface 616. The I/O interface 616 can be configured to support the input/output of data. In some embodiments, the I/O interface 616 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 600 can be configured to synchronize with another device to transfer content to and/or from the mobile device 600. In some embodiments, the mobile device 600 can be configured to receive updates to one or more of the applications 610 via the I/O interface 616, though this is not necessarily the case. In some embodiments, the I/O interface 616 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 616 may be used for communications between the mobile device 600 and a network device or local device.

The mobile device 600 also can include a communications component 618. The communications component 618 can be configured to interface with the processor 604 to facilitate wired and/or wireless communications with one or more networks. In some embodiments, the communications component 618 includes a multimode communications subsystem for facilitating communications via the cellular network and one or more other networks.

The communications component 618, in some embodiments, includes one or more transceivers. The one or more transceivers, if included, can be configured to communicate over the same and/or different wireless technology standards with respect to one another. For example, in some embodiments one or more of the transceivers of the communications component 618 may be configured to communicate using GSM, CDMAONE, CDMA2000, LTE, and various other 2G, 2.5G, 3G, 4G, 6G and greater generation technology standards. Moreover, the communications component 618 may facilitate communications over various channel access methods (which may or may not be used by the aforementioned standards) including, but not limited to, TDMA, FDMA, W-CDMA, OFDM, SDMA, and the like.

In addition, the communications component 618 may facilitate data communications using GPRS, EDGE, the HSPA protocol family including HSDPA, EUL or otherwise termed HSUPA, HSPA+, and various other current and future wireless data access standards. In the illustrated embodiment, the communications component 618 can include a first transceiver (“TxRx”) 620A that can operate in a first communications mode (e.g., GSM). The communications component 618 also can include an Nth transceiver (“TxRx”) 620N that can operate in a second communications mode relative to the first transceiver 620A (e.g., UMTS). While two transceivers 620A-N (hereinafter collectively and/or generically referred to as “transceivers 620”) are shown in FIG. 6, it should be appreciated that less than two, two, or more than two transceivers 620 can be included in the communications component 618.

The communications component 618 also can include an alternative transceiver (“Alt TxRx”) 622 for supporting other types and/or standards of communications. According to various contemplated embodiments, the alternative transceiver 622 can communicate using various communications technologies such as, for example, WI-FI, WIMAX, BLUETOOTH, BLE, infrared, infrared data association (“IRDA”), near field communications (“NFC”), other RF technologies, combinations thereof, and the like.

In some embodiments, the communications component 618 also can facilitate reception from terrestrial radio networks, digital satellite radio networks, internet-based radio service networks, combinations thereof, and the like. The communications component 618 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 600 also can include one or more sensors 624. The sensors 624 can include temperature sensors, light sensors, air quality sensors, movement sensors, orientation sensors, noise sensors, proximity sensors, or the like. As such, it should be understood that the sensors 624 can include, but are not limited to, accelerometers, magnetometers, gyroscopes, infrared sensors, noise sensors, microphones, combinations thereof, or the like. One or more of the sensors 624 can be used to detect movement of the mobile device 600. Additionally, audio capabilities for the mobile device 600 may be provided by an audio I/O component 626. The audio I/O component 626 of the mobile device 600 can include one or more speakers for the output of audio signals, one or more microphones for the collection and/or input of audio signals, and/or other audio input and/or output devices.

The illustrated mobile device 600 also can include a subscriber identity module (“SIM”) system 628. The SIM system 628 can include a universal SIM (“USIM”), a universal integrated circuit card (“UICC”) and/or other identity devices. The SIM system 628 can include and/or can be connected to or inserted into an interface such as a slot interface 630. In some embodiments, the slot interface 630 can be configured to accept insertion of other identity cards or modules for accessing various types of networks. Additionally, or alternatively, the slot interface 630 can be configured to accept multiple subscriber identity cards. Because other devices and/or modules for identifying users and/or the mobile device 600 are contemplated, it should be understood that these embodiments are illustrative, and should not be construed as being limiting in any way.

The mobile device 600 also can include an image capture and processing system 632 (“image system”). The image system 632 can be configured to capture or otherwise obtain photos, videos, and/or other visual information. As such, the image system 632 can include cameras, lenses, CCDs, combinations thereof, or the like. The mobile device 600 may also include a video system 634. The video system 634 can be configured to capture, process, record, modify, and/or store video content. Photos and videos obtained using the image system 632 and the video system 634, respectively, may be added as message content to an MMS message, email message, and sent to another mobile device. The video and/or photo content also can be shared with other devices via various types of data transfers via wired and/or wireless communication devices as described herein.

The mobile device 600 also can include one or more location components 636. The location components 636 can be configured to send and/or receive signals to determine a specific location of the mobile device 600. According to various embodiments, the location components 636 can send and/or receive signals from GPS devices, A-GPS devices, WI-FI/WIMAX and/or cellular network triangulation data, combinations thereof, and the like. The location component 636 also can be configured to communicate with the communications component 618 to retrieve triangulation data from the mobile telecommunications network for determining a location of the mobile device 600. In some embodiments, the location component 636 can interface with cellular network nodes, telephone lines, satellites, location transmitters and/or beacons, wireless network transmitters and receivers, combinations thereof, and the like. In some embodiments, the location component 636 can include and/or can communicate with one or more of the sensors 624 such as a compass, an accelerometer, and/or a gyroscope to determine the orientation of the mobile device 600. Using the location component 636, the mobile device 600 can generate and/or receive data to identify its geographic location, or to transmit data used by other devices to determine the location of the mobile device 600. The location component 636 may include multiple components for determining the location and/or orientation of the mobile device 600.

The illustrated mobile device 600 also can include a power source 638. The power source 638 can include one or more batteries, power supplies, power cells, and/or other power subsystems including alternating current (“AC”) and/or direct current (“DC”) power devices. The power source 638 also can interface with an external power system or charging equipment via a power I/O component 640. Because the mobile device 600 can include additional and/or alternative components, the above embodiment should be understood as being illustrative of one possible operating environment for various embodiments of the concepts and technologies described herein. The described embodiment of the mobile device 600 is illustrative, and should not be construed as being limiting in any way.

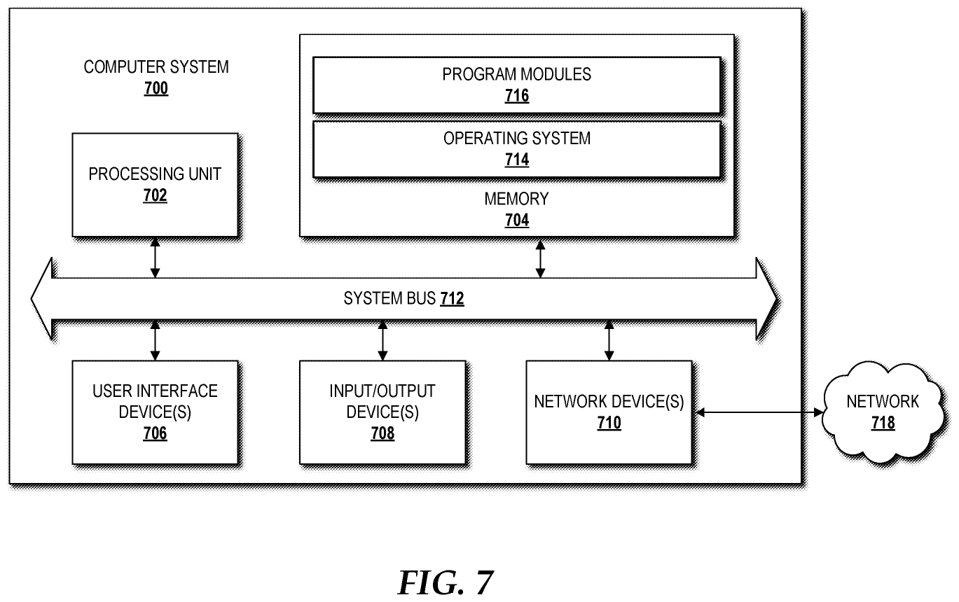

FIG. 7 is a block diagram illustrating a computer system 700 configured to provide the functionality in accordance with various embodiments of the concepts and technologies disclosed herein. In some embodiments, components of the hardware resource layer 502, systems associated with the services 110, the clients 106A, 106B or portions thereof, the cloud-native firewall system 302 or portions thereof, and/or any other systems described herein can be configured, at least in part, like the architecture of the computer system 700. It should be understood, however, that modification to the architecture may be made to facilitate certain interactions among elements described herein.

The computer system 700 includes a processing unit 702, a memory 704, one or more user interface devices 706, one or more input/output (“I/O”) devices 708, and one or more network devices 710, each of which is operatively connected to a system bus 712. The bus 712 enables bi-directional communication between the processing unit 702, the memory 704, the user interface devices 706, the I/O devices 708, and the network devices 710.

The processing unit 702 may be a standard central processor that performs arithmetic and logical operations, a more specific purpose programmable logic controller (“PLC”), a programmable gate array, or other type of processor known to those skilled in the art and suitable for controlling the operation of the server computer. Processing units are generally known, and therefore are not described in further detail herein.

The memory 704 communicates with the processing unit 702 via the system bus 712. In some embodiments, the memory 704 is operatively connected to a memory controller (not shown) that enables communication with the processing unit 702 via the system bus 712. The illustrated memory 704 includes an operating system 714 and one or more program modules 716. The operating system 714 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, OS X, and/or iOS families of operating systems from APPLE CORPORATION, the FREEBSD family of operating systems, the SOLARIS family of operating systems from ORACLE CORPORATION, other operating systems, and the like.

The program modules 716 may include various software and/or program modules to perform the various operations described herein. The program modules 716 and/or other programs can be embodied in computer-readable media containing instructions that, when executed by the processing unit 702, perform various operations such as those described herein. According to embodiments, the program modules 716 may be embodied in hardware, software, firmware, or any combination thereof.

By way of example, and not limitation, computer-readable media may include any available computer storage media or communication media that can be accessed by the computer system 700. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 700. In the claims, the phrase “computer storage medium” and variations thereof does not include waves or signals per se and/or communication media.

The user interface devices 706 may include one or more devices with which a user accesses the computer system 700. The user interface devices 706 may include, but are not limited to, computers, servers, PDAs, cellular phones, or any suitable computing devices. The I/O devices 708 enable a user to interface with the program modules 716. In one embodiment, the I/O devices 708 are operatively connected to an I/O controller (not shown) that enables communication with the processing unit 702 via the system bus 712. The I/O devices 708 may include one or more input devices, such as, but not limited to, a keyboard, a mouse, or an electronic stylus. Further, the I/O devices 708 may include one or more output devices, such as, but not limited to, a display screen or a printer. In some embodiments, the I/O devices 708 can be used for manual controls for operations to exercise under certain emergency situations.

The network devices 710 enable the computer system 700 to communicate with other networks or remote systems via a network 718. Examples of the network devices 710 include, but are not limited to, a modem, a radio frequency (“RF”) or infrared (“IR”) transceiver, a telephonic interface, a bridge, a router, or a network card. The network 718 may include a wireless network such as, but not limited to, a Wireless Local Area Network (“WLAN”), a Wireless Wide Area Network (“WWAN”), a Wireless Personal Area Network (“WPAN”) such as provided via BLUETOOTH technology, a Wireless Metropolitan Area Network (“WMAN”) such as a WiMAX network or metropolitan cellular network. Alternatively, the network 718 may be a wired network such as, but not limited to, a Wide Area Network (“WAN”), a wired Personal Area Network (“PAN”), or a wired Metropolitan Area Network (“MAN”). The network 718 may be any other network described herein.

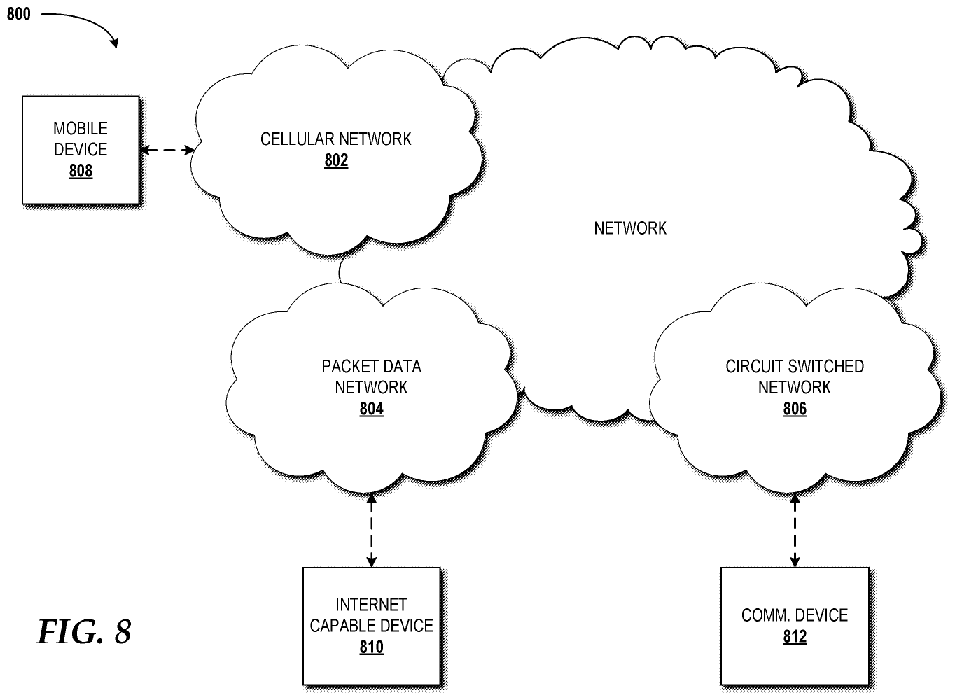

Turning now to FIG. 8, details of a network 800 are illustrated, according to an illustrative embodiment. The network 800 includes a cellular network 802, a packet data network 804, for example, the Internet, and a circuit switched network 806, for example, a PSTN. The cellular network 802 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 802 also includes radios and nodes for receiving and transmitting voice, data, and combinations thereof to and from radio transceivers, networks, the packet data network 804, and the circuit switched network 806.

A mobile communications device 808, such as, for example, one of the clients 106A, 106B a cellular telephone, a user equipment, a mobile terminal, a PDA, a laptop computer, a handheld computer, and combinations thereof, can be operatively connected to the cellular network 802. The cellular network 802 can be configured as a 2G GSM network and can provide data communications via GPRS and/or EDGE. Additionally, or alternatively, the cellular network 802 can be configured as a 3G UMTS network and can provide data communications via the HSPA protocol family, for example, HSDPA, EUL (also referred to as HSUPA), and HSPA+. The cellular network 802 also is compatible with 4G mobile communications standards such as LTE, or the like, as well as evolved and future mobile standards.

The packet data network 804 includes various devices, for example, servers, computers, databases, and other devices in communication with another, as is generally known. The packet data network 804 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. The circuit switched network 806 includes various hardware and software for providing circuit switched communications. The circuit switched network 806 may include, or may be, what is often referred to as a POTS. The functionality of a circuit switched network 806 or other circuit-switched network are generally known and will not be described herein in detail.

The illustrated cellular network 802 is shown in communication with the packet data network 804 and a circuit switched network 806, though it should be appreciated that this is not necessarily the case. One or more Internet-capable devices 810, a PC, a laptop, a portable device, or another suitable device, can communicate with one or more cellular networks 802, and devices connected thereto, through the packet data network 804. It also should be appreciated that the Internet-capable device 810 can communicate with the packet data network 804 through the circuit switched network 806, the cellular network 802, and/or via other networks (not illustrated).

As illustrated, a communications device 812, for example, a telephone, facsimile machine, modem, computer, or the like, can be in communication with the circuit switched network 806, and therethrough to the packet data network 804 and/or the cellular network 802. It should be appreciated that the communications device 812 can be an Internet-capable device, and can be substantially similar to the Internet-capable device 810. In the specification, the network is used to refer broadly to any combination of the networks 802, 804, 806 shown in FIG. 8.

Based on the foregoing, it should be appreciated that concepts and technologies directed to a cloud-native firewall have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A cloud-native firewall system comprising:
a processor; and
a memory comprising computer-executable instructions associated with a cloud-native firewall that, when executed by the processor, cause the processor to perform operations comprising
receiving, from a client operating in a first network, a request for access to a service operating in a second network,
in response to the request, retrieving, from a service registry, metadata associated with the service, and
executing, based at least in part upon the metadata, a policy rule to determine whether to allow or deny the client access to the service.

2. The cloud-native firewall system of claim 1, wherein the metadata comprises a dynamic IP address associated with a system that provides, at least in part, the service.

3. The cloud-native firewall system of claim 2, wherein the metadata further comprises a port number associated with the system that provides, at least in part, the service.

4. The cloud-native firewall system of claim 3, wherein the metadata further comprises an authentication type.

5. The cloud-native firewall system of claim 4, wherein the metadata further comprises an authentication provider.

6. The cloud-native firewall system of claim 1, wherein the service registry comprises a first service registry instance operating in the first network; wherein the metadata associated with the service is obtained by the first service registry instance via synchronization with a second service registry instance operating in the second network; and wherein the service provides the metadata to the second service registry instance during a registration process.

7. A method comprising:
receiving, by a cloud-native firewall system, from a client operating in a first network, a request for access to a service operating in a second network;
in response to the request, retrieving, by the cloud-native firewall system, from a service registry, metadata associated with the service; and
executing, by the cloud-native firewall system, based at least in part upon the metadata, a policy rule to determine whether to allow or deny the client access to the service.

8. The method of claim 7, wherein the metadata comprises a dynamic IP address associated with a system that provides, at least in part, the service.

9. The method of claim 8, wherein the metadata further comprises a port number associated with the system that provides, at least in part, the service.

10. The method of claim 9, wherein the metadata further comprises an authentication type.

11. The method of claim 10, wherein the metadata further comprises an authentication provider.

12. The method of claim 7, wherein the service registry comprises a first service registry instance operating in the first network; wherein the metadata associated with the service is obtained by the first service registry instance via synchronization with a second service registry instance operating in the second network; and wherein the service provides the metadata to the second service registry instance during a registration process.

13. The method of claim 7, further comprising, in response to determining to allow the client access to the service, forwarding the request to the service for processing.

14. The method of claim 7, further comprising, in response to determining to deny the client access to the service, blocking the client access to the service.

15. A computer-readable storage medium having computer-executable instructions stored thereon that, when executed by a processor, cause the processor to perform operations comprising:
receiving, from a client operating in a first network, a request for access to a service operating in a second network;
in response to the request, retrieving, from a service registry, metadata associated with the service; and
executing, based at least in part upon the metadata, a policy rule to determine whether to allow or deny the client access to the service.

16. The computer-readable storage medium of claim 15, wherein the metadata comprises a dynamic IP address and a port number associated with a system that provides, at least in part, the service.

17. The computer-readable storage medium of claim 16, wherein the metadata further comprises an authentication type.

18. The computer-readable storage medium of claim 17, wherein the metadata further comprises an authentication provider.

19. The computer-readable storage medium of claim 15, wherein the operations further comprise, in response to determining to allow the client access to the service, forwarding the request to the service for processing.

20. The computer-readable storage medium of claim 15, wherein the operations further comprise, in response to determining to deny the client access to the service, blocking the client access to the service.
